(19) United States
(12) Patent Application Publication
(10) Pub. No.: US 2013/0287111 A1
(43) Pub. Date: Oct. 31, 2013

(54) LOW MEMORY ACCESS MOTION VECTOR DERIVATION

(71) Applicants: Lidong Xu, Beijing (CN); Yi-Jen Chiu, San Jose, CA (US); Wenhao Zhang, Beijing (CN)

(72) Inventors: Lidong Xu, Beijing (CN); Yi-Jen Chiu, San Jose, CA (US); Wenhao Zhang, Beijing (CN)

(21) Appl. No.: 13/976,778

(22) PCT Filed: Jun. 29, 2011
(86) PCT No.: PCT/US11/42292

§ 371 Date: Jun. 27, 2013

Related U.S. Application Data
(60) Provisional application No. 61/452,843, filed on Mar. 15, 2011.

(51) Int. Cl. H04N 7/36

(52) U.S. Cl. CPC H04N 19/00678; H04N 19/00684
USPC 375/240.16

(57) ABSTRACT

Systems, devices and methods for performing low memory access candidate-based decoder-side motion vector determination (DMVD) are described. The number of candidate motion vectors (MVs) searched may be confined by limiting the range of pixels associated with candidate MVs to a pre-defined window. Reference windows may then be loaded into memory only once for both DMVD and motion compensation (MC) processing. Reference window size may be adapted to different PU sizes. Further, various schemes are described for determining reference window positions.

### RELATED APPLICATIONS

This application claims is priority to and benefit of U.S. Provisional Patent Application No. 61/452,843, filed on Mar. 15, 2011. This application is related to U.S. patent application Ser. Nos. 12/566,823, filed on Sep. 25, 2009; 12/567,540, filed on Sep. 25, 2009; 12/582,061, filed on Oct. 20, 2009; 12/657,168, filed on Jan. 14, 2010; and U.S. Provisional Patent Application No. 61/390,461, filed on Oct. 6, 2010.

### BACKGROUND

A video picture may be coded in a Largest Coding Unit (LCU). A LCU may be a 128×128 block of pixels, a 64×64 block, a 32×32 block or a 16×16 block. Further, an LCU may be encoded directly or may be portioned into smaller Coding Units (CUs) for next level encoding. A CU in one level may be encoded directly or may be further divided into a next level for encoding as desired. In addition, a CU of size 2N×2N may be divided into various sized Prediction Units (PU), for example, one 2N×2N PU, two 2N×N PUs, two N×2N PUs, or four N×N PUs. If a CU is inter-coded, motion vectors (MVs) may be assigned to each sub-partitioned PU.

Video coding systems typically use an encoder to perform motion estimation (ME). An encoder may estimate MVs for a current encoding block. The MVs may then be encoded within a bit stream and transmitted to a decoder where motion compensation (MC) may be undertaken using the MVs. Some coding systems may employ decoder-side motion vector derivation (DMVD) using a decoder to perform ME for PUs instead of using MVs received from an encoder. DMVD techniques may be candidate based where ME process may be constrained by searching among a limited set of pairs of candidate MVs. However, traditional candidate based DMVD may entail searching among an arbitrarily large number of possible MV candidates and this may in turn require reference picture windows to be repeatedly loaded into memory to identify a best candidate.

### BRIEF DESCRIPTION OF THE DRAWINGS/FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video encoder system;

FIG. 2 is an illustrative diagram of an example video decoder system;

FIG. 3 is a diagram illustrating example mirror ME at a decoder;

FIG. 4 is a diagram illustrating example projective ME at a decoder;

FIG. 5 is a diagram illustrating example spatial neighbor block ME at a decoder;

FIG. 6 is a diagram illustrating example temporal collocated block ME at a decoder;

FIG. 7 is a diagram illustrating example ME at a decoder;

FIG. 8 is to diagram illustrating example reference window specifications:

FIG. 9 is an illustration of an example process;

FIG. 10 is an illustration of an example system; and

FIG. 11 is an illustration of an example system, all arranged in accordance with at least some implementations of the present disclosure.

### DETAILED DESCRIPTION

One or more embodiments are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques au or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may implemented by any execution environment for similar purposes. For example, various architectures, for example architectures employing multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementation whether or not explicitly described.

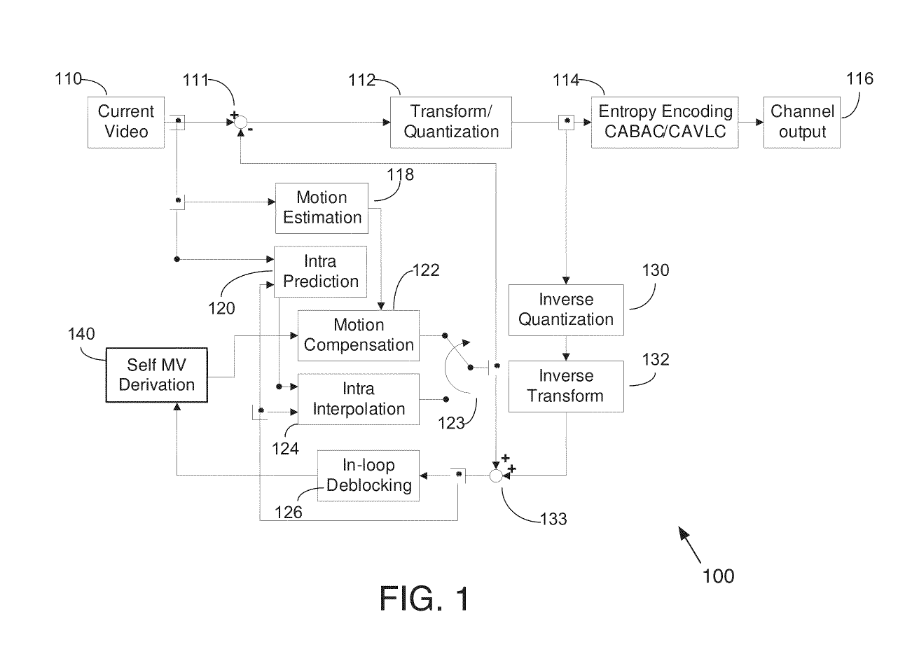

Material described herein may be implemented in the context of a video encoder/decoder system that undertakes video compression and/or decompression. FIG. 1 illustrates an example video encoder 100 that may include a self motion vector (MV) derivation module 140. Encoder 100 may implement one or more advanced video codec standards, such as, for example, the ITU-T H.264 standard, published March, 2003. Current video information may be provided from a current video block 110 in the form of a plurality of frames of video data. The current video may be passed to a differencing unit 111. The differencing unit 111 may be part of the Differential Pulse Code Modulation (DPCM) (also called the core video encoding) loop, which may include a motion compensation (MC) stage 122 and a motion estimation (ME) stage 118. The loop may also include an intra prediction stage 120, and intra interpolation stage 124. In some cases, an in-loop deblocking filter 126 may also be used in the DPCM loop.

The current video may be provided to the differencing unit 111 and to the ME stage 118. The MC stage 122 or the intra interpolation stage 124 may produce an output through a switch 123 that may then be subtracted from the current video 110 to produce a residual. The residual may then be transformed and quantized at transform/quantization stage 112 and subjected to entropy encoding in block 114. A channel output may result at block 116.

The output of motion compensation stage 122 or intra-interpolation stage 124 may be provided to a summer 133 that may also receive an input from inverse quantization unit 130 and inverse transform unit 132. The inverse quantization unit 130 and inverse transform unit 132 may provide dequantized and detransformed information back to the loop.

Self MV derivation module 140 may implement, at least in part, the various DMVD processing schemes described herein for derivation of a MV as will be described in greater detail below. Self MV derivation module 140 may receive the output of in-loop deblocking filter 126, and may provide an output to motion compensation stage 122.

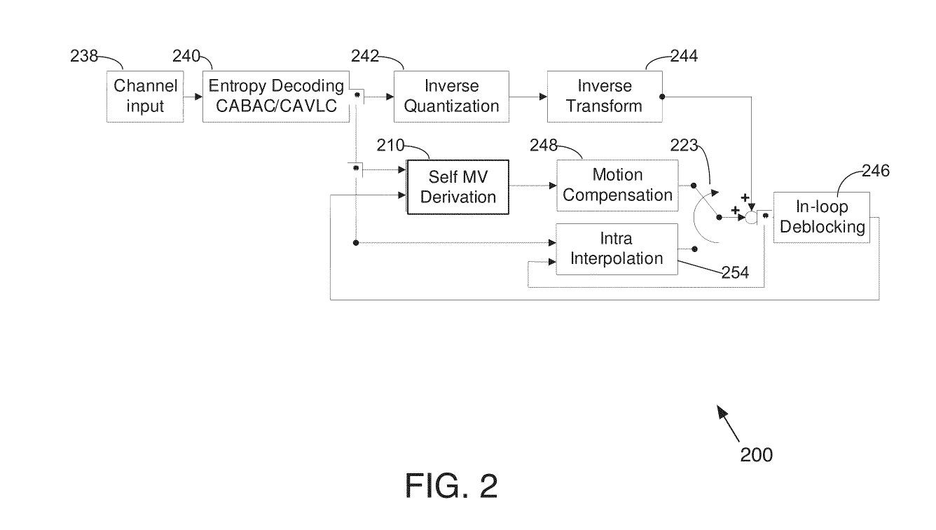

FIG. 2 illustrates a video decoder 200 including a self MV derivation module 210. Decoder 200 may implement one or more advanced video codec standards, such as, for example, the H.264 standard. Decoder 200 may include a channel input 238 coupled to an entropy decoding unit 240. Channel input 238 may receive input from the channel output of an encoder such as encoder 100 of FIG. 1. Output from decoding unit 240 may be provided to an inverse quantization unit 242, to an inverse transform unit 244, and to self MV derivation module 210. Self MV derivation module 210 may be coupled to a motion compensation (MC) unit 248. The output of entropy decoding unit 240 may also be provided to intra interpolation unit 254, which may feed a selector switch 223. Information from inverse transform unit 244, and either MC unit 248 or intra interpolation unit 254 as selected by the switch 223, may then be summed and provided to an in-loop de-blocking unit 246 and fed back to intra interpolation unit 254. The output of the in-loop deblocking unit 246 may then be provided to self MV derivation module 210.

n various implementations self MV derivation module 140 of encoder 100 of FIG. 1 may synchronize with self MV derivation module 210 of decoder 200 as will be explained in greater detail below. In various configurations self MV derivation modules 140 and/or 210 may be implemented in a generic video codec architecture, and are not limited to any specific coding architecture such as the H.264 coding architecture.

The encoder and decoder described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

### Motion Vector Derivation

Motion vector derivation may be based, at least in part, on the assumption that the motions of a current coding block may have strong correlations with those of spatially neighboring blocks and those of temporally neighboring blocks in reference pictures. For instance, candidate MVs may be selected from the MVs of temporal and spatial neighboring PUs where a candidate includes a pair of MVs pointing to respective reference windows. A candidate with minimum sum of absolute differences (SAD) calculated between pixel values of the two reference windows may be selected as a best candidate. The best candidate may then be directly used to encode the PU or may be refined to obtain more accurate MVs for PU encoding.

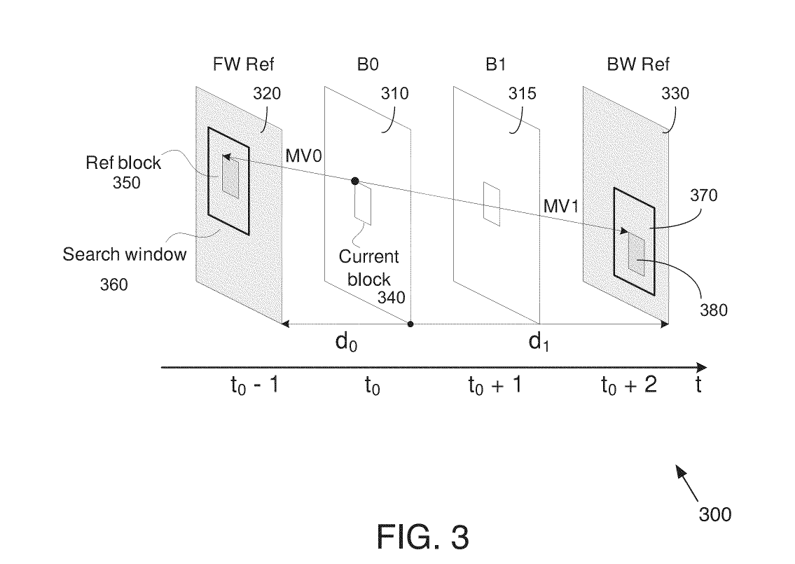

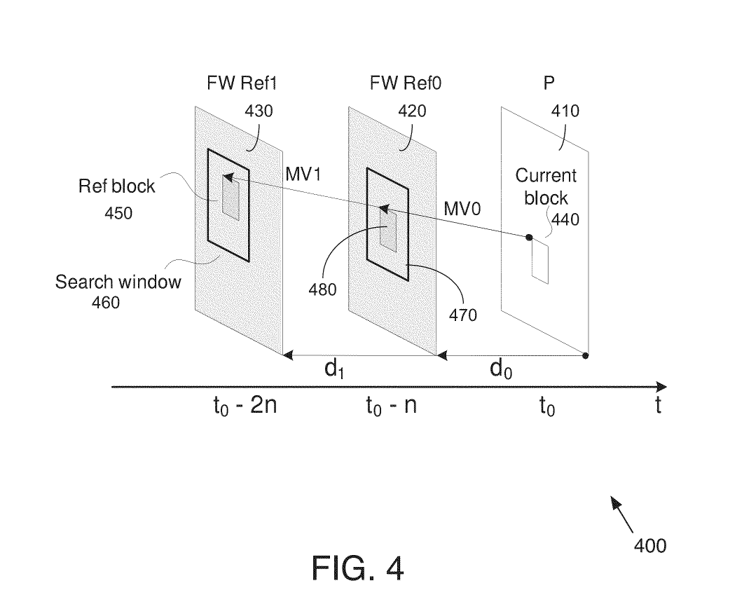

Various schemes may be employed to implement motion vector derivation. For example, the mirror ME scheme illustrated in FIG. 3 and projective ME scheme illustrated in FIG. 4 may be performed between two reference frames using temporal motion correlation. In the implementation of FIG. 3, there may be two bi-predictive frames (B frames), 310 and 315, between a forward reference frame 320 and a backward reference frame 330. Frame 310 may be the current encoding frame. When encoding the current block 340, a mirror ME may obtain MVs by performing searches within search windows 360 and 370 of reference frames 320 and 330, respectively. In implementations where the current input block may not be available at the decoder, mirror ME may be performed with the two reference frames.

FIG. 4 illustrates an example projective ME scheme 400 that may use two forward reference frames, forward (FW) Ref0 (shown as reference frame 420) and FW Ref1 (shown as reference frame 430). Reference frames 420 and 430 may be used to derive a MV for a current target block 440 in a current frame P (shown as frame 410). A search window 470 may be specified in reference frame 420, and a search path may be specified in search window 470. A projective MV (MV1) may be determined in search window 460 of reference frame 430 for each motion vector MV0 in a search path. For each pair of MVs, MV0 and MV1, a metric, such as a SAD, may be calculated between (1) the reference block 480 pointed to by the MV0 in reference frame 420, and (2) the reference block 450 pointed to by the MV1 in reference frame 430. The motion vector MV0 that yields the optimal value for the metric, e.g., the minimal SAD, may then be chosen as the MV for target block 440.

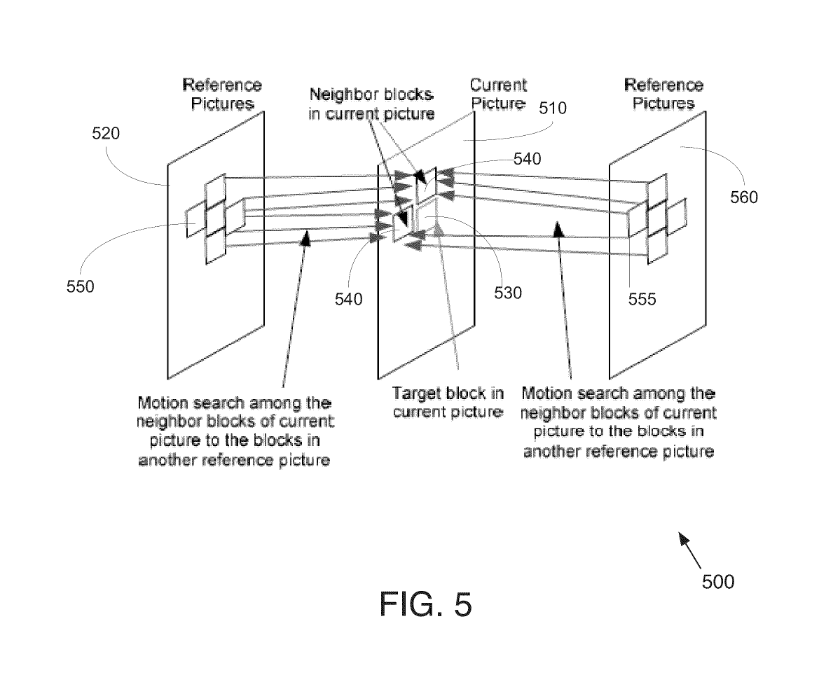

To improve the accuracy of the output MVs for a current block, various implementations may take into account the spatial neighboring reconstructed pixels in the measurement metric of decoder side ME. In FIG. 5, decoder side ME may be performed on the spatially neighboring blocks by taking advantage of spatial motion correlation. FIG. 5 illustrates an example implementation 500 that may utilize one or more neighboring blocks 540 (shown here as blocks above and to the left of the target block 530) in a current picture (or frame) 510. This may allow generation of a. MV based on one or more corresponding blocks 550 and 555 in a previous reference frame 520 and a subsequent reference frame 560, respectively, where the terms “previous” and “subsequent” refer to temporal order between the frames. The MV may then be applied to target block 530. In some implementations, a raster scan coding order may be used to determine spatial neighbor blocks above, to the left, above and to the left, and above and to the right of the target block. This approach may be used for example with B frames, which use both preceding and following frames for decoding.

The approach illustrated in FIG. 5 may be applied to available pixels of spatially neighboring blocks in a current frame, as long as the neighboring blocks were decoded prior to the target block in sequential scan coding order. Moreover, this approach may apply motion search with respect to reference frames in reference frame lists for a current frame.

The processing of the embodiment of FIG. 5 may take place as follows. First, one or more blocks of pixels may be identified in the current frame, where the identified blocks neighbor the target block of the current frame. Motion search for the identified blocks may then be performed, based on corresponding blocks in a temporally subsequent reference frame and on corresponding blocks in a temporally previous reference frame. The motion search may result in MVs associated with the identified blocks. Alternatively, the MVs associated with the neighboring blocks may be determined prior to identification of those blocks. The MVs associated with the neighboring blocks may then be used to derive the MV for the target block, which may then be used for motion compensation for the target block. The MV derivation may be performed using any suitable process known to persons of ordinary skill in the art. Such a process may be, for example and without limitation, weighted averaging or median filtering. Overall, schemes such as the scheme illustrated in FIG. 5 may be implemented as at least part of a candidate-based decoder-side MV derivation (DMVD) process.

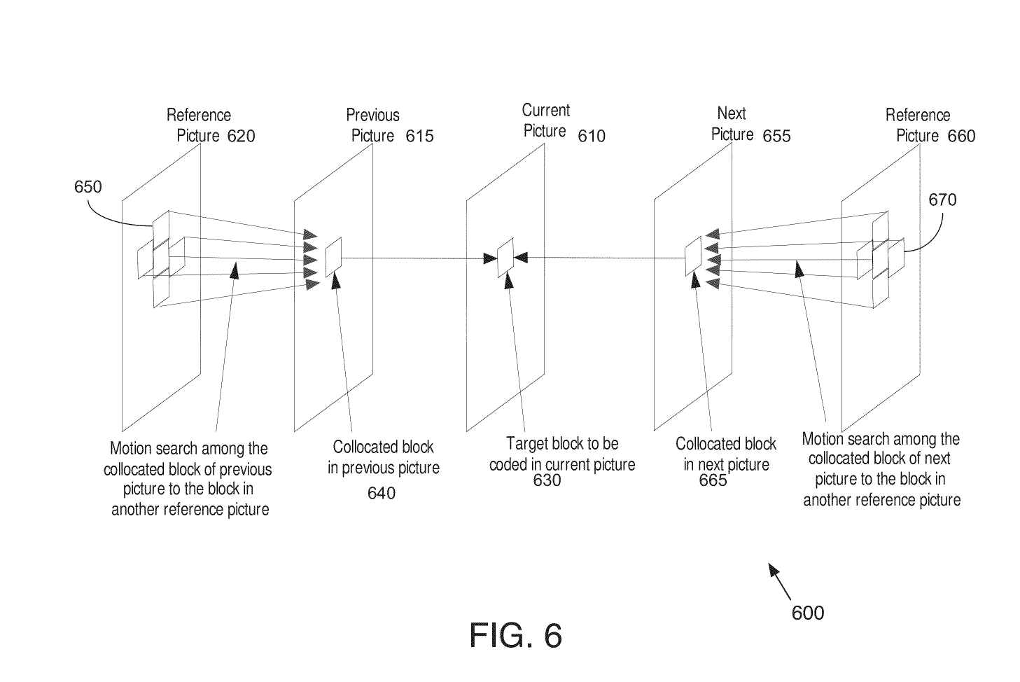

Corresponding blocks of previous and succeeding reconstructed frames, in temporal order, may be used to derive a MV. This approach is illustrated in FIG. 6. To encode a target block 630 in a current frame 610, already decoded pixels may be used, where these pixels may be found in a corresponding block 640 of a previous picture, shown here as picture 615, and in a corresponding block 665 of a next frame, shown as picture 655. A first MV may be derived for corresponding block 640, by performing a motion search through one or more blocks 650 of the reference frame, picture 620. Block(s) 650 may neighbor a block in reference frame 620 that corresponds to block 640 of previous picture 615. A second MV may be derived for corresponding block 665 of next frame 655, by performing a motion search through one or more blocks 670 of reference picture, i.e., frame 660. Block(s) 670 may neighbor a block in reference picture 660 that corresponds to block 665 of next frame 655. Based on the first and second MVs, forward and/or backward MVs for target block 630 may be determined. These latter MVs may then be used for motion compensation for the target block.

ME processing for schemes such as illustrated in FIG. 6 may be undertaken as follows. Initially, a block may be identified in a previous frame, where this identified block may correspond to the target block of the current frame. A first MV may be determined for this identified block of the previous frame, where the first MV may be defined relative to a corresponding block of a first reference frame. A block may be identified in a succeeding frame, where this block may correspond to the target block of the current frame. A second MV may be determined for this identified block of the succeeding frame, where the second MV may be defined relative to the corresponding block of a second reference frame. One or two MVs may be determined for the target block using the respective first and second MVs above. Analogous processing may take place at the decoder.

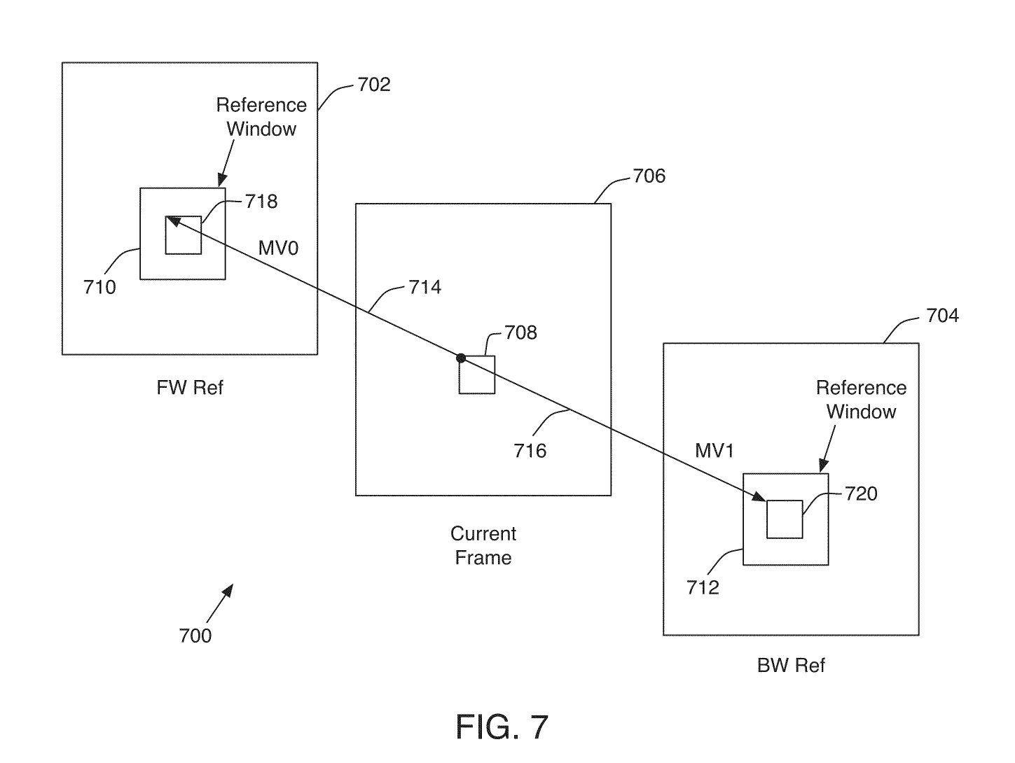

FIG. 7 illustrates an example bi-directional ME scheme 700 that may use portions of a forward reference frame (FW Ref) 702 and portions of a backward reference frame (BW Ref) 704 to undertake DMVD processing for portions of a current frame 706. In the example of scheme 700 a target block or PU 708 of current frame 706 may be estimated using one or more MVs derived with respect to reference frames 702 and 704. To provide DMVD in accordance with the present disclosure, MV candidates may be chosen from a set of MVs restricted to those MVs that point to PUs associated with a reference windows 710 and 712, of specified size, located in reference frames 702 and 704, respectively. For instance, the centers of windows 710 and 712 may be specified by respective MVs 714 (MV0) and 716 (MV1) pointing to PUs 718 and 720 of reference frames 702 and 704, respectively.

In accordance with the present disclosure, ME processing for to portion of a current frame may include loading reference pixel windows into memory only once for performing both DMVD and MC operations on that portion. For instance, ME processing for PU 708 of current frame 706 may include loading into memory pixel data (e.g., pixel intensity values) for all pixels encompassed by window 710 in FW reference frame 702 and for all pixels encompassed by window 712 in BW reference frame 704. Continued ME processing of PU 708 may then include accessing only those stored pixel values to both identify a best MV candidate pair using DMVD techniques and to use that best MY candidate pair to perform MC for PU 708.

While scheme 700 may appear to describe an ME scheme for PUs having square (e.g., M×M) aspect ratios, the present disclosure is not limited to coding schemes employing particular sizes or aspect rations of encoding blocks, CUs, PUs and so forth. Hence, schemes in accordance with the present disclosure may employ image frames specified by any arrangement, size and/or aspect ratio of PUs. Thus, in general, PUs in accordance with the present disclosure may have any size or aspect ratio M×N. In addition, while scheme 700 describes bi-directional ME processing, the present disclosure is not limited in this regard.

### Motion Vector Confinement

In accordance with the present disclosure, memory usage may be curtailed by limiting the pixels values utilized for the purposes of undertaking DMVD to derive MVs and for the purposes of undertaking MC filtering operations. In various implementations, as noted above, this may be achieved by limiting DMVD and/or MC processing to only those pixels values corresponding to two reference windows and by loaded those pixel values into memory only once. Hence, for example, the process of calculating a candidate MV metric (e.g., calculating the SAD for a candidate MV) to identify a best candidate MV and the process of using that candidate MV to undertake MC processing may be accomplished by reading the stored pixel values without required repeated operations to load new pixel values into memory.

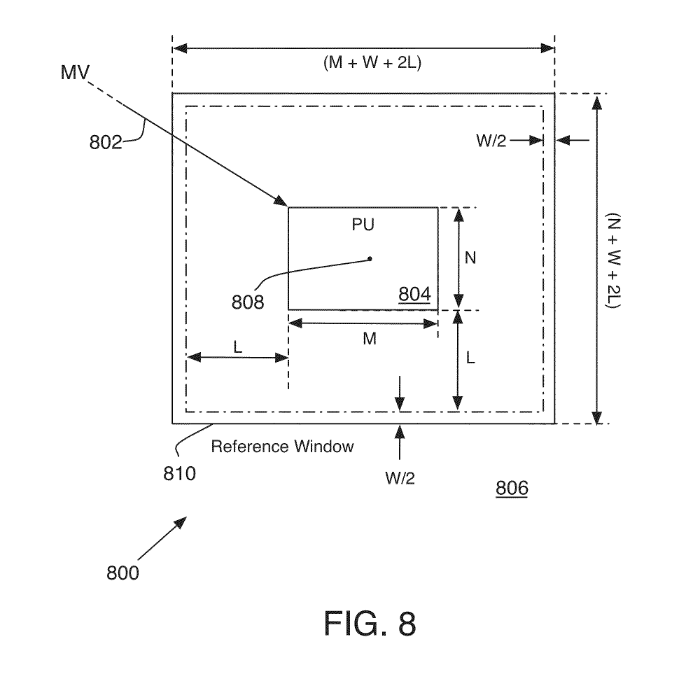

FIG. 8 illustrates an example reference window scheme 800 in accordance with the present disclosure. For instance, either of windows 710 and 712 of scheme 700 may employ windows having sizes in accordance with scheme 800. In scheme 800 a motion vector MV 802 of an example MV pair associated with a PU of size M×N in a current frame (not shown) points to a PU 804 of size M×N in a reference frame 806. The center position 808 of PU 804 also serves as the center of a corresponding reference window 810 of specific size.

In accordance with the present disclosure, the size or extent of a reference window associated with PU of size M×N (e.g., having height N and width M1 may be specified to have a size of (M+2L+W) in one dimension (e.g., width M) and a size of (N+2L+W) in the orthogonal dimension (e.g., height N), where M, L and W are positive integers, where W corresponds to an adjustable fractional ME parameter, and where L corresponds to an adjustable window size parameter as will be described in greater detail below. For instance, in the example of FIG. 8, reference window 810 spans a total of (M+2L+W)×(N+2L+W) pixels in reference frame 806. For instance, for example values of M=8, N=4, L=4 and W=2, reference window 810 may span 14 pixels in height by 18 pixels in width or 252 pixels total in reference frame 806. In various implementations, the values of the adjustable fractional ME parameter W may be determined in accordance with well-known techniques for undertaking fractional ME.

Referring again to an example implementation where M=8, N=4, L=4 and W=2, performing ME processing in accordance with the present disclosure for a PU of a current frame (not shown) may include loading into memory only once the values corresponding to the 252 pixels encompassed h reference window 810. In addition, performing ME processing in accordance with the present disclosure for a PU of a current frame would also include loading into memory only once the 252 values of pixels encompassed by a second reference window of size (M+2L+W)×(N+2L+W) located in a second reference frame (not shown in FIG. 8). Continuing the example, DMVD and MC processing for the PU of the current frame may then be undertaken by accessing only the 504 total stored pixel values.

While FIG. 8 illustrates a scheme 800 in which reference window 810 has a size defined tin part) by a single value of adjustable window size parameter L, in various implementations, L may have different values for the two reference window dimensions. For instance, in accordance with the present disclosure, a process for performing DMVD and MC processing on an M×N PU may include loading integer pixel windows of size (M+W+2L0)×(N+W+2L1) where L0≠L1. For example, for a having dimensions M=4 and N=8, different values of L0=4 and L1=8 may be chosen such that a corresponding reference window may (assuming W=2) have a size of 14 by 26 pixels (e.g., would encompass 364 pixels).

By specifying the size of reference windows in accordance with the present disclosure, the number of candidate MVs used in ME processing may be limited to those MVs that point to locations within the limits of the defined reference windows. For example, for window centers (center_0.x, center_0.y) and (center_1.x, center_1.y) in two reference frames, a pair of MVs, (Mv_0.x, Mv_0.y) and (Mv_1.x, Mv_1.y), may be designated as an available MV candidate if the component MVs satisfy the following conditions:

$$\{ \begin{matrix}- {a}_{0} \leq Mv\_ 0. x - center\_ 0. x \leq {b}_{0} \\ - {a}_{1} \leq Mv\_ 0. y - center\_ 0. y \leq {b}_{1} \\ - {a}_{0} \leq Mv\_ 1. x - center\_ 1. x \leq {b}_{0} \\ - {a}_{1} \leq Mv\_ 1. y - center\_ 1. y \leq {b}_{1}\end{matrix} \qquad [ 1 ]$$

where aᵢ and bᵢ (i=0, 1) are configurable MV confinement parameters. For example, for implementations not employing MV refinement, confinement parameters aᵢ and bᵢ may be selected that satisfy the conditions of aᵢ≦Lᵢ and bᵢ≦Lᵢ+0.75, while for implementations employing MV refinement, confinement parameters aᵢ and bᵢ may be selected that satisfy the conditions of aᵢ≦Lᵢ−0.75 and bᵢ≦Lᵢ. In either case, coding performance may improve if the largest values of aᵢ and bᵢ are chosen such that those values satisfy the aforementioned conditions. In various implementations Lᵢ may take any positive integer value such as, for example, positive even-valued integers (e.g., 2, 4, 8, 12, etc.).

In accordance with the present disclosure, reference window size may be limited to specific values and; or may be dynamically determined during ME processing. Thus, in various implementations, the value of parameters Lᵢ, and hence the reference window size (assuming fixed W), may remain fixed regardless of the size(s) of PUs being coded. For example, Lᵢ=8 may be applied to all PUs coded regardless of PU size. However, in various implementations, reference window sizes may also be dynamically adjusted by specifying different values for window size parameters Lᵢ. Thus, for example, in various implementations, different pre-defined reference windows having fixed sizes may be loaded into memory as L value(s) are adjusted in response to changes in the size of PUs being ME processed. For example, as each PU is being ME processed, parameters Lᵢ may be dynamically adjusted to be equal to half of each lei's height and/or width. Further, in some implementations, parameters Lᵢ may be adjustable only within certain limits. In such implementations, for example, parameters Lᵢ may be adjustable up to a maximum pre-defined value. For instance, Lᵢ may be set such that Lᵢ=4 for all values M,N≦8 While for values M,N>8 the value Lᵢ=8 may be applied, etc.

In addition, in accordance with the present disclosure, different schemes may be employed to select locations of reference windows for ME processing. Thus, in various implementations, various schemes may be employed to determine the best candidate MVs to be used to determine the locations of the reference windows. In various implementations, positions of the reference pixel windows may be selected from a fixed or predetermined candidate MV such as to zero MV candidate, to collocated. MV candidate, a candidate of a spatial neighboring MV, the average MV of some candidates, or the like.

In addition, in various implementations, rounded MVs for a specific candidate MV may be used to determine the location of a reference window. In other words, if a MV does not point to an integer pixel position, the MV may be rounded to the nearest integer pixel position, or may be rounded to a top-left neighboring pixel position, to name a few non-limiting examples.

Further, in some implementations, reference pixel window position may be determined adaptively by deriving the position from some or all of the available candidates. For instance, reference window position may be determined by specifying a set of potential windows having different centers and then selecting a particular window position that includes the largest number of candidate MVs satisfying Eqn. (1). In addition, more than one set of potential windows having different centers may be specified and then ranked to determine a particular window position that includes the largest number of other candidate MVs satisfying Eqn. (1).

### DMVD Processing

As mentioned above, specifying a limited size of reference windows in accordance with the present disclosure, may limit the candidate MVs used in ME processing to those MVs that point to locations within the limits of the defined reference windows. Once reference window locations and sizes have been specified as described herein for a given PU, the PU may be DMVD processed by calculating a metric, such as SAD, for all candidate MVs that, for example, satisfy Eqn. (1) for that NJ. By doing so, the MVs foliating the candidate MV that best satisfies the metric (i.e., that provides the lowest SAD value) may then be used to perform MC processing for the PU using various well-known MC techniques.

Further, in accordance with the present disclosure, MV refinement may be performed within the loaded reference pixel windows. In various implementations, candidate MVs may be forced to integer pixel positions by rounding them to the nearest whole pixels. The rounded candidate MVs may then be checked, and the candidate having a minimum metric value (e.g., SAD value) may be used as the final derived MV. In some implementations, the original un-rounded MV corresponding to a best rounded candidate MV may used as the final derived MV.

Moreover, in various implementations, after identifying a best rounded candidate MV, small range integer pixel refinement ME around the best rounded candidate may be performed. The best refined integer MV resulting from this search may then be used as the final derived MV. In addition, in various implementations, after performing small range integer pixel refinement ME and obtaining the best refined integer MV, an intermediate position may be used. For example, a middle position between the best refined integer MV and the best rounded candidate may be identified and the vector corresponding to this intermediate position may then be used as the final derived MV.

In various implementations, an encoder and corresponding decoder may use the same MV candidates. For instance, as shown in FIG. 1, encoder 100 includes self MV derivation module 140 that may employ the same MV candidates as employed by self MY derivation module 210 of decoder 200 (FIG. 2). Video coding systems including encoders such as encoder 100 and decoders such as decoder 200 may undertake synchronized DMVD in accordance with the present disclosure. In various implementations, an encoder may provide control data to a decoder where the control data informs the decoder that, for a given PU, the decoder should undertake DMVD processing for that PU. In other words, rather than sending the decoder an MV for that PU, the encoder may send control data informing the decoder that it should derive an MV for that PU, For instance, for a given PU, encoder 100 may provide, within a video data bit stream, control data in the form of one or more control bits to decoder 200 informing decoder 200 that it should undertake DMVD processing for that PU.

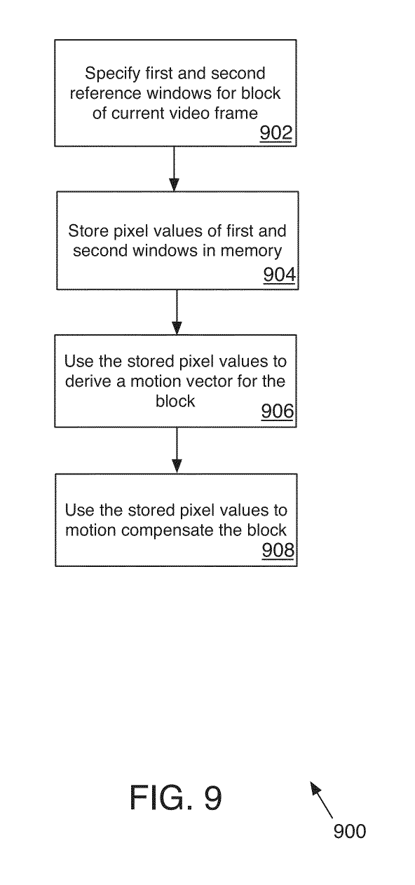

FIG. 9 illustrates a flow diagram of an example process 900 for low memory access motion vector derivation according to various implementations of the present disclosure. Process 900 may include one or more operations, functions or actions as illustrated by one or more of blocks 902, 904, 906, and/or 908. In various implementations, process 900 may be undertaken at a decoder such as, for example, decoder 200 of FIG. 2.

Process 900 may begin at block 902 where reference windows may be specified, as described herein, for a block, such as a PU, of a current video frame. At block 904, pixel values of the reference windows may be loaded into memory. MV derivation and MC as described herein may be undertaken in respective blocks 906 and 908 employing the pixel values loaded into memory in block 904. While FIG. 9 illustrates a particular arrangement of blocks 902, 904, 906, and 908, the present disclosure is not limited in this regard and processes for low memory access motion vector derivation according to various implementations of the present disclosure may include other arrangements.

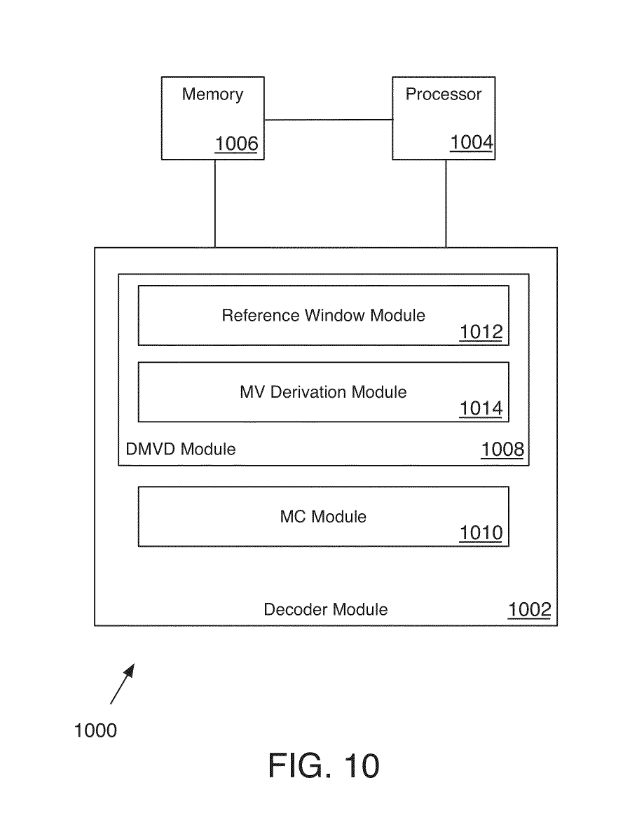

FIG. 10 illustrates an example DMVD system 1000 in accordance with the present disclosure. System 1000 may be used to perform some or all of the various functions discussed herein and may include any device or collection of devices capable of undertaking low memory access motion vector derivation processing in accordance with the present disclosure. For example, system 1000 may include selected components of a computing platform or device such as a desktop, mobile or tablet computer, a smart phone, a set for box, etc., although the present disclosure is not limited in this regard.

System 1000 may include a video decoder module 1002 operably coupled to a processor 1004 and memory 1006. Decoder module 1002 may include a DMVD module 1008 and a MC module 1010. DMVD module 1008 may include a reference window module 1012 and a MV derivation module 1014 and may be configured to undertake, in conjunction with processor 1004 and/or memory 1006, any of the processes described herein and/or any equivalent processes. In various implementations, referring to the example decoder 200 of FIG. 2, DMVD module 1008 and a MC module 1012 may be provided by self MV derivation module 210 and MC unit 248, respectively. Decoder module 1002 may include additional components, such as an inverse quantization module, inverse transform module and so forth, not depicted in FIG. 10 in the interest of clarity. Processor 1004 may be a SoC or microprocessor or Central Processing Unit (CPU). In other implementations, processor 1004 may be an Application Specific Integrated Circuit (ASIC), a Field Programmable Gate Array (FPGA), a digital signal processor (DSP), or other integrated formats.

Processor 1004 and module 1002 may be configured to communicate with each other and with memory 1006 by any suitable means, such as, for example, by wired connections or wireless connections. Moreover, system 1000 may implement decoder 200 of FIG. 2. Further, system 1000 may include additional components and/or devices such as transceiver logic, network interface logic, etc. that have not been depicted in FIG. 10 in the interests of clarity.

While FIG. 10 depicts decoder module 1002 separately from processor 1004, those skilled in the art will recognize that decoder module 1002 may be implemented in any combination of hardware, software, and/or firmware and that, therefore, decoder module 1002 may be implemented, at least in part, by software logic stored in memory 1006 and/or as instructions executed by processor 1004. For instance, decoder module 1002 may be provided to system 1000 as instructions stored on a machine-readable medium. In some implementations, decoder module 1002 may include instructions stored in internal memory (not shown) of processor.

Memory 1006 may store reference window pixel values as described herein. For example, pixel values stored in memory 1006 may be loaded into memory 1006 in response to reference window module 1012 specifying the size and location of those reference windows as described herein. MV derivation module 1014 and MC module 1010 may then access the pixel values stored in memory 1006 when undertaking respective MV derivation and MC processing. Thus, in various implementations, specific components of system 1000 may undertake one or more of the blocks of example process 900 of FIG. 9 as described herein. For example, reference window module 1012 may undertake block 902 and 904 of process 900, while MV derivation module 1014 may undertake block 906 and MC module 1010 may undertake block 908.

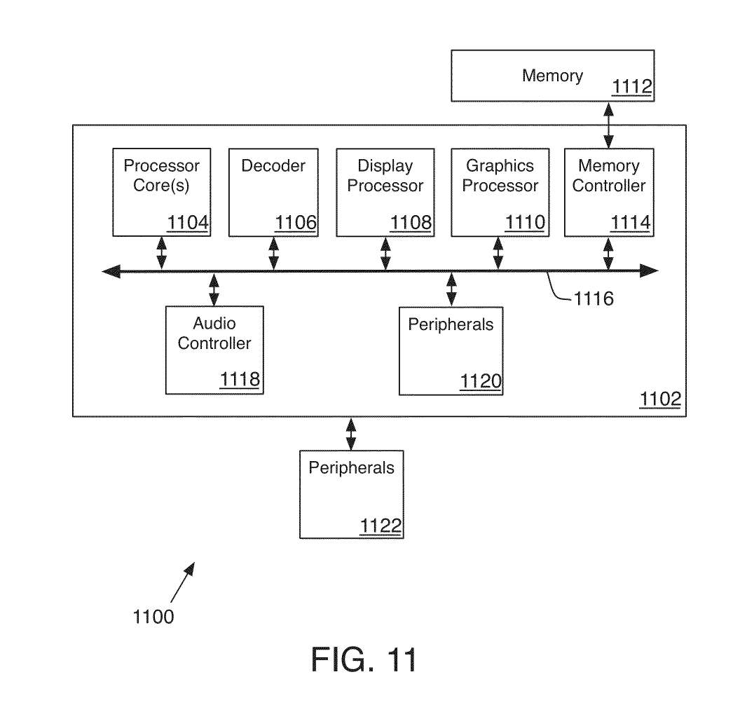

FIG. 11 illustrates an example system 1100 in accordance with the present disclosure. System 1100 may be used to perform some or all of the various functions discussed herein and may include any device or collection of devices capable of undertaking low memory access motion vector derivation in accordance with various implementations of the present disclosure. For example, system 1100 may include selected components of a computing platform or device such as a desktop, mobile or tablet computer, a smart phone, etc., although the present disclosure is not limited in this regard. In some implementations, system 1100 may be a computing platform or SoC based on Intel® architecture (IA). It will be readily appreciated by one of skill in the art that the implementations described herein can be used with alternative processing systems without departure from the scope of the present disclosure.

System 1100 includes a processor 1102 having one or more processor cores 1104. Processor cores 1104 may be any type of processor logic capable at least in part of executing software and/or processing data signals. In various examples, processor cores 1104 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor or microcontroller. While not illustrated in FIG. 11 in the interest of clarity, processor 1102 may be coupled to one or more co-processors (on-chip or otherwise). Thus, in various implementations, other processor cores (not shown) may be configured to undertake low memory access motion vector derivation in conjunction with processor 1102 in accordance with the present disclosure.

Processor 1102 also includes a decoder 1106 that may be used for decoding instructions received by, e.g., a display processor 1108 and/or a graphics processor 1110, into control signals and/or microcode entry points. While illustrated in system 1100 as components distinct from core(s) 1104, those of skill in the art may recognize that one or more of core(s) 1104 may implement decoder 1106, display processor 1108 and/or graphics processor 1110. In some implementations, core(s) 1104 may be configured to undertake any of the processes described herein including the example processes described with respect to FIG. 9. Further, in response to control signals and/or microcode entry points, core(s) 1104, decoder 1106, display processor 1108 and/or graphics processor 1110 may perform corresponding operations.

Processing core(s) 1104, decoder 1106, display processor 1108 and/or graphics processor 1110 may be communicatively and/or operably coupled through a system interconnect 1116 with each other and/or with various other system devices, which may include but are not limited to, for example, a memory controller 1114, an audio controller 1118 and/or peripherals 1120. Peripherals 1120 may include, for example, a unified serial bus (USB) host port, a Peripheral Component Interconnect (PCI) Express port, a Serial Peripheral Interface (SPI) interface, an expansion bus, and/or other peripherals. While FIG. 11 illustrates memory controller 1114 as being coupled to decoder 1106 and the processors 1108 and 1110 by interconnect 1116, in various implementations, memory controller 1114 may be directly coupled to decoder 1106, display processor 1108 and/or graphics processor 1110.

In some implementations, system 1100 may communicate with various I/O devices not shown in FIG. 11 via an bus (also not shown). Such I/O devices may include but are not limited to, for example, a universal asynchronous receiver/transmitter (DART) device, a USB device, an I/O expansion interface or other I/O devices. In various implementations, system 1100 may represent at least portions of a system for undertaking mobile, network and/or wireless communications.

System 1100 may further include memory 1112. Memory 1112 may be one or more discrete memory components such as a dynamic random access memory (DRAM) device, a static random access memory (SRAM) device, flash memory device, or other memory devices. While FIG. 11 illustrates memory 1112 as being external to processor 1102, in various implementations, memory 1112 may be internal to processor 1102. Memory 1112 may store instructions and/or data represented by data signals that may be executed by the processor 1102. In some implementations, memory 1112 may store reference window pixel values.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed is:

1. A method, comprising:
at a video decoder,
specifying, for a block in a current video frame, a first window of pixel values associated with a first reference video frame, and a second window of pixel values associated with a second reference video frame;
storing pixel values of the first and second reference video frames in memory to provide stored pixel values, the stored pixel values being limited to pixel values of the first window and pixel values of the second window;
using the stored pixel values to derive a motion vector (MV) for the block; and
using the MV to motion compensate (MC) the block.

2. The method of claim 1, wherein using the stored pixel values to derive the MV for the block comprises using only the stored pixel values to derive the MV for the block.

3. The method of claim 1, wherein using the stored pixel values to derive the MV for the block comprises using the stored pixel values to derive the MV for the block without using other pixel values of the first and second reference video frames to derive the MV for the block.

4. The method of claim 1, wherein the block comprises a prediction unit of size (M×N) wherein M and N comprise non-zero positive integers, wherein the first window comprises an integer pixel window of size (M+W+2L), wherein W and L comprise non-zero positive integers, and wherein the first window comprises an integer pixel window of size (N+W+2L), the method further comprising:
determining a value of L in response to at least one of a value of M or a value of N.

5. The method of claim 4, wherein determining a value of L in response to at least one of a value of M or a value of N comprises adaptively determining different values of L in response to different values of (M×N).

6. The method of claim 1, wherein specifying the first window comprises specifying a first window center in response to a MV candidate pair, and wherein specifying the second window comprises specifying a second window center in response to the MV candidate pair.

7. The method of claim 6, wherein the MV candidate pair includes at least one of a zero MV, a MV of a temporal neighboring block of the first or second reference video frame, a MV of a spatially neighboring block of the current video frame, a median filtered MV, or an average MV.

8. The method of claim 6, wherein specifying the first window center and the second window center in response to the MV candidate pair comprises adaptively specifying the first window center and the second window center.

9. The method of claim 8, wherein in adaptively specifying the first window center and the second window center comprises specifying the first window center and the second window center in response to a largest number of MAT candidate pairs satisfying the conditions
$$\{ \begin{matrix}- {a}_{0} \leq Mv\_ 0. x - center\_ 0. x \leq {b}_{0} \\ - {a}_{1} \leq Mv\_ 0. y - center\_ 0. y \leq {b}_{1} \\ - {a}_{0} \leq Mv\_ 1. x - center\_ 1. x \leq {b}_{0} \\ - {a}_{1} \leq Mv\_ 1. y - center\_ 1. y \leq {b}_{1}\end{matrix}$$
wherein a₁ and bᵢ (i=0, 1) comprises configurable MV confinement parameters, wherein (Mv_0.x, Mv_0.y) and (Mv_1.x, Mv_1.y) comprise candidate MV pairs, wherein (center_0.x, center_0.y) comprises the first window center, and wherein (center_1.x, center_1.y) comprises the second window center.

10. The method of claim 1, further comprising:
receiving, from a video encoder, control data indicating that the decoder should specify the first window and the second window.

11. A system, comprising:
memory to store pixel values of a first reference window and a second reference window; and
one or more processor cores coupled to the memory, the one or more processor cores to:
specify, for a block in a current video frame, the first reference window and the second reference window;
store the pixel values in the memory;
use the stored pixel values to derive a motion vector (MV) for the block; and
use the MV to motion compensate (MC) the block, wherein the one or more processor cores limit the pixel values used to derive the MY and to MC the block to the pixel values of the first reference window and the second reference window stored in the memory.

12. The system of claim 11, wherein the block comprises a prediction unit of size (M×N) wherein M and N comprise non-zero positive integers, wherein the first reference window comprises an integer pixel window of size (M+W+2L), wherein W and L comprise non-zero positive integers, and wherein the first reference window comprises an integer pixel window of size (N+W+2L), the one or more processor cores to:
determine a value of L in response to at least one of a value of M or a value of N.

13. The system of claim 12, wherein to determine a value of L in response to at least one of a value of M or a value of N, the one or more processor cores are configured to adaptively determine different values of L in response to different values of (M×N).

14. The system of claim 11, wherein to specify the first reference window the one or more processor cores are configured to specify a first window center in response to a MV candidate pair, and Wherein to specify the second reference window the one or more processor cores are configured to specify a second window center in response to the MV candidate pair.

15. The system of claim 14, wherein the MV candidate pair includes at least one of a zero MV, a MV of a collocated block of the first reference video frame, a MV of a spatially neighboring block of the current video frame, a median filtered MV, or an average MV.

16. The system of claim 14, wherein to specify the first reference window center and the second reference window center the one or more processor cores are configured to adaptively specify the first reference window center and the second reference window center.

17. An article comprising a computer program product having stored therein instructions that, if executed, result in:
at one or more processor cores,
specifying, liar a block in a current video frame, a first window of pixel values associated with a first reference video frame, and a second window of pixel values associated with a second reference video frame;
storing pixel values of the first and second reference video frames in memory to provide stored pixel values, the stored pixel values being limited to pixel values of the first window and pixel values of the second window;
using the stored pixel values to derive a motion vector (MV) for the block; and
using the MV to motion compensate (MC) the block.

18. The article of claim 17, wherein using the stored pixel values to derive the MN for the block comprises using only the stored pixel values to derive the MV for the block.

19. The article of claim 17, wherein using the stored pixel values to derive the MV for the block comprises using the stored pixel values to derive the MV for the block without using other pixel values of the first and second reference video frames to derive the MV for the block.

20. The article of claim 17, wherein the block comprises a prediction unit of size (M×N) wherein M and N comprise non-zero positive integers, wherein the first window comprises an integer pixel window of size (M+W+2L), wherein W and L comprise non-zero positive integers, and wherein the first window comprises an integer pixel window of size (N++2L), the article further having stored therein instructions that, if executed, result in:
determining a value of L in response to at least one of a value of M or a value of N.

21. The article of claim 20, wherein determining a value of L in response to at least one of a value of M or a value of N comprises adaptively determining different values of L in response to different values of (M×N).

22. The article of claim 17, wherein specifying the first window comprises specifying a first window center in response to a MV candidate pair, and wherein specifying the second window comprises specifying a second window center in response to the MV candidate pair.

23. The article of claim 22, wherein the MV candidate pair includes at least one of a zero MV, a MV of a temporal neighboring block of the first or second reference video frame, a MV of a spatially neighboring block of the current video frame, a median filtered MV, or an average MV.

24. The article of claim 22, wherein specifying the first window center and the second window center in response to the MV candidate pair comprises adaptively specifying the first window center and the second window center.

25. The article of claim 24, wherein in adaptively specifying the first window center and the second window center comprises specifying the first window center and the second window center in response to a largest number of MV candidate pairs satisfying the conditions
$$\{ \begin{matrix}- {a}_{0} \leq Mv\_ 0. x - center\_ 0. x \leq {b}_{0} \\ - {a}_{1} \leq Mv\_ 0. y - center\_ 0. y \leq {b}_{1} \\ - {a}_{0} \leq Mv\_ 1. x - center\_ 1. x \leq {b}_{0} \\ - {a}_{1} \leq Mv\_ 1. y - center\_ 1. y \leq {b}_{1}\end{matrix}$$
wherein aᵢ and bᵢ (i=0, 1) comprises configurable MV confinement parameters, wherein (Mv_0.x, Mv_0.y) and (Mv_1.x, Mv_1.y) comprise candidate MV pairs, wherein (center_0.x, center_0.y) comprises the first window center, and wherein (center_1.x, center_1.y) comprises the second window center.

26. The article of claim 17, the article further having stored therein instructions that, if executed, result in:
receiving, from a video encoder, control data indicating that the decoder should specify the first window and the second window.
